(19) United States
(12) Patent Application Publication
(10) Pub. No.: US 2013/0120437 A1
(43) Pub. Date: May 16, 2013

(54) DISPLAY CONTROLLING UNIT, IMAGE DISPLAYING SYSTEM AND METHOD FOR OUTPUTTING IMAGE DATA

(71) Applicants: Kshitij Bajaj, Ghaziabad (IN); Michael Staudenmaier, Munich (DE)

(72) Inventors: Kshitij Bajaj, Ghaziabad (IN); Michael Staudenmaier, Munich (DE)

(73) Assignee: Freescale Semiconductor Inc., Austin, TX (US)

(21) Appl. No.: 13/810,746

(22) PCT Filed: Jul. 20, 2010
(86) PCT No.: PCT/IB2010/053303

§ 371 Date: Jan. 17, 2013

(51) Int. Cl. G06T 5/00

(52) U.S. Cl. CPC G06T 5/00
USPC 345/597; 345/581

(57) ABSTRACT

A display controlling unit comprises an input connectable to receive input image data representing an input image comprising a first set and a second set of image elements. The second set of image elements comprises a safety relevant information. The display controlling unit also comprises an output connectable to provide output image data representing an output image at least comprising the safety relevant information, an image enhancement module arranged to perform an image enhancement processing for the first set of image elements when a safety mode signal indicates a first mode, and a verification module arranged to perform a verification processing for the second set of image elements when the safety mode signal indicates a second mode.

### FIELD OF THE INVENTION

This invention relates to a display controlling unit, an image displaying system and a method for outputting image data.

### BACKGROUND OF THE INVENTION

Information and entertainment systems and consumer entertainment devices may employ sophisticated graphical schemes for providing the user with high quality images or video.

Today, the systems are available for environments where multiple sources of visual information are available. For example, in a vehicle, a display may be used for both providing entertainment, video or navigation information or any other non-safety-relevant information and safety relevant information, such as for example vehicle speed and engine temperature, at the same time.

Image enhancement methods can be applied to the image data to be displayed, especially when processing digital image data, for improving image quality, reducing noise or visibility of errors. The same or similar enhancement method may be used for providing images having the same visual quality but displayed on a display or screen able to provide only reduced quality parameter values, such as color resolution or signal-to-noise ratio. The reduced color resolution may lead to sub-optimal optical results especially when slight color changes are displayed, for example when displaying image gradients.

For example, temporal dithering is a technique for emulating a color resolution higher than the maximum color resolution supported by the display. Using temporal dithering allows achieving a better subjective optical result at only few additional costs using the same display. Liquid crystal displays (LCD), such as thin-film transistor (TFT) displays, e.g. low cost RGB666 color TFT displays, available e.g. for in-vehicle usage, often have a color resolution of not more than six bits per color component, which is below the color resolution of the human eye.

The color values of the image elements or picture elements (pixels) are usually calculated with full accuracy, which may for example be eight bits, wherein at the output of a display controller the least significant bits of the image element or its color components are just cut off, causing additional quantization error, which may become visible in the displayed image. Dithering may allow for spreading the quantization error and may therefore enable optically better results on displays such as color TFT screens.

Referring to FIG. 1, a diagram of an example of temporal dithering of a value V of a pixel color component over time T, i.e. in a sequence of images, is schematically shown. In the shown example, the real 8-bit value 127 (dec)=0x7F (hex) encounters a reduction of accuracy by cutting off two bits, giving 124 (dec)=0x7C (hex). Temporal dithering does not just cut off the remaining bits, but it adds a random value greater equal zero and less than 1, with an average value of about 0.5. As shown in FIG. 1, this leads to an alternation 10 of the output value 127, giving the ideal eight bit value as an average value 12 over time T for a specific pixel.

On the other hand, safety relevant information is displayed using other display systems which are set up to guarantee the integrity of the safety critical information.

In WO 2009/141684 a display controller is shown which is adapted to check the correctness of the pixel data by comparing them with a reference. This is achieved by calculating cyclic redundancy check (CRC) values on the data sent to the display and comparing them with the reference value.

### SUMMARY OF THE INVENTION

The present invention provides a display controlling unit, an image displaying system and a method for outputting image data as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a diagram of an example of prior art temporal dithering of a value of a pixel color component over time.

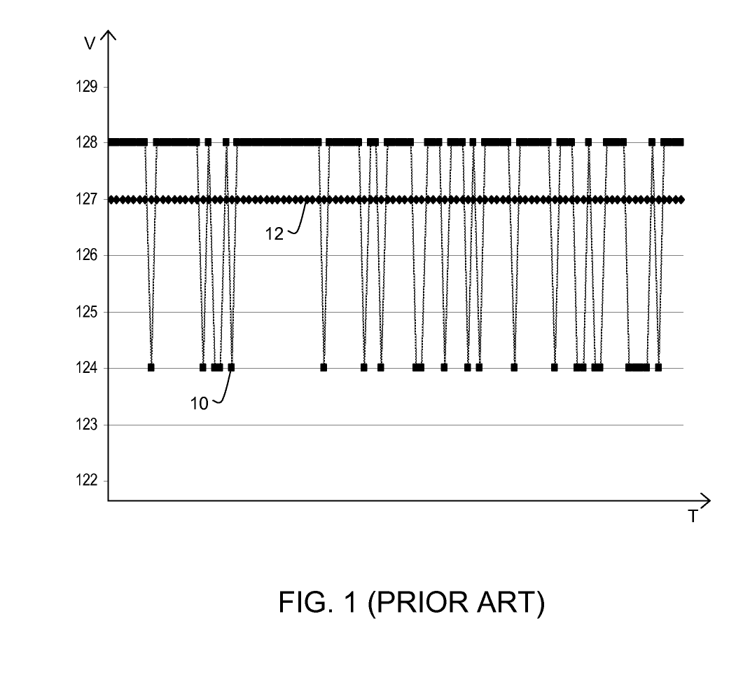

FIG. 2 schematically shows an example of an embodiment of an image displaying system comprising an example of an embodiment of a display controlling unit.

FIG. 3 schematically shows an example of an embodiment of an image enhancement module according to an embodiment of the display controlling unit.

FIG. 4 schematically shows a diagram of an example of an embodiment of a method for outputting image data.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary as illustrated, for the understanding and appreciation of the underlying concepts of the present invention and in order not to obfuscate or distract from the teachings of the present invention.

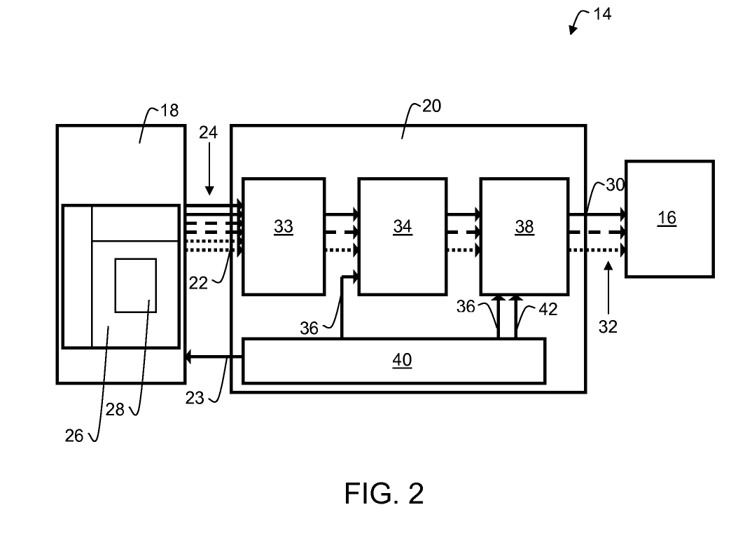

Referring to FIG. 2, an example of an embodiment of an image displaying system 14 comprising an example of an embodiment of a display controlling unit 20 is schematically shown. An image displaying system 14 may comprise a display 16 connected to receive output image data and arranged to output an image in a for humans perceptible form, at least one image data source 18 connected to provide input image data, and a display controlling unit 20 as described by example embodiment below. The display controlling unit 20 may be arranged to provide an address signal 23 to the image data source for requesting image data corresponding to the provided address.

A display 16 may be any display device or screen arranged to show images or sequences of images in a for humans perceptible form, such as for example an LCD, TFT or plasma display or organic light emitting diode (OLED) display or the screen of a cathode ray tube (CRT) monitor.

An image data source 18 may for example be a memory device comprising images for signalling safety critical information when displayed on a display screen 16. Or it may be a memory or cache holding not safety-critical information, such as for example navigation data, video or even live image sequences for example provided by a camera such as a surveillance camera. Or it may for example be a combination of both.

In some embodiments, an image displaying system may comprise more than one display for displaying different image data or simultaneously displaying the same image data.

The image displaying system 14 may be comprised in an apparatus, wherein a user of the system uses the same display for perceiving non-safety-relevant and safety critical information, for example simultaneously. An apparatus may for example be a vehicle, such as a car, a truck, a plane, a helicopter, a train or a ship. Or it may for example be part of any machine for industrial or medical application having a display for providing a visual interface to the user, wherein machine failure or malfunction may result in a safety critical situation, for example for the user or the machine.

As an example, safety relevant or safety critical information related to a vehicle may be any information, such as current speed, headlamp control or engine temperature or any status information provided to the user of any safety critical system of the vehicle. A safety critical system of a vehicle may comprise a seat position control system, lighting, windscreen wipers, immobilizers, a brake system or an electrical steering system. A brake system may comprise, for example, an anti-lock braking system (ABS) or an electronic brakeforce distribution system (EBD). An electrical steering system may comprise, for example, an electronic stability control system (ESC), a traction control system (TCS) or anti-slip regulation system (ASR), an adaptive cruise control (ACC) system, a forward collision warning (FCW) system, just to name a few.

A display controlling unit 20 may comprise an input 22 connectable to receive input image data representing an input image 24 comprising a first set 26 and a second set 28 of image elements; the second set 28 of image elements comprising a safety relevant information. And the display controlling unit 20 may comprise an output 30 connectable to provide output image data representing an output image 32 at least comprising the safety relevant information, an image enhancement module 34 arranged to perform an image enhancement processing for the first set 26 of image elements when a safety mode signal 36 indicates a first mode, and a verification module 38 arranged to perform a verification processing for the second set 28 of image elements when the safety mode signal 36 indicates a second mode. The second mode and the first mode may not be the same mode, i.e. the safety mode signal may not be in first mode and second mode at the same time.

The first and second sets 26, 28 of image elements may comprise one or more than one image element. For a display screen based on displaying pixels, i.e. picture elements, an image element may correspond to a picture element. In another embodiment, the second set of image elements 28 may comprise no image elements during normal operation, i.e. when no safety relevant information is to be displayed. In yet another embodiment, the first set 26 of image elements may comprise no image elements when displaying an alert message across the whole display screen 16. And in an embodiment of the display controlling unit 20, the unit may be arranged to operate according to some or all embodiments mentioned above, depending on the currently displayed safety relevant information.

The safety mode signal, which may comprise at least two levels or be adapted to signal at least the first and the second mode, may indicate, that the value of the image element currently processed may be allowed to be changed during an image enhancement processing, when in first or enhanced quality mode, and that the value of the currently processed image element may be protected, assuming it to be relevant for displaying safety relevant information, when in second or safety mode.

The safety mode signal 36 may for example be provided by an external controlling unit or in another embodiment may be encoded within the stream of input image data. Or the display controlling unit 20, may comprise a safety mode controlling module 40 connected to the image enhancement module 34 and the verification module 38, arranged to provide the safety mode signal 36. This may, for example, allow for a single-chip solution for the shown display controller unit. Or in an embodiment, the display controlling unit may be the controlling unit or a part of it inside a TFT display or functionality of the display controlling unit may be split between an external controller and a TFT controller inside the display device. Instead of a TFT display, or additionally, other display devices and corresponding controllers may be used.

In an embodiment, the display controlling unit 20 may be adapted to provide the second set 28 of image elements to a specific section of a display 16 connectable to the output 30, the section dedicated to displaying the safety critical information, i.e. a section of the display 16 may be selected for displaying safety critical information and the second set 28 of image elements may be defined by the target output area on the display 16, no matter if the currently processed image elements contain safety relevant information or not. A specific section of the display screen 16 may be declared safety critical and the affected image elements may be marked by the display controlling unit 20 as being protected, preventing any change of values by image enhancement processing. This may also for example allow for easily providing a position information signal 42 to the verification module 38 in order to control which image elements to include in the verification processing.

Many image enhancement methods are known, for example for smoothing edges, balancing color distribution, detecting peak errors etc. The shown image enhancement module may be arranged to apply a noise signal to the first set 26 of image elements. Whereas this may even reduce parameter values for determining signal quality, such as for example the signal-to-noise ratio, noise may enable a more positive subjective perception of the displayed image, since for example noise may allow to conceal artefacts such as pixel errors or edges related to a high quantization error of the displayed quantized values of digital image elements.

The image enhancement module 34 may for example be arranged to dither the first set 26 of image elements. Dither is an intentionally applied form of noise used to randomize quantization error. Dithering may be applied spatially, with respect to the image elements surrounding the element to be dithered. Or dithering may comprise a temporal dithering of the first set 26 of image elements. Dithering may allow to emulate higher color resolution on a display, such as for example a TFT display with limited color resolution, depending on the higher color resolution available in the graphic content of data. This may then be emulated on a limited resolution display.

The display controlling unit may be arranged to output a sequence of images, such as video frames or graphic animations.

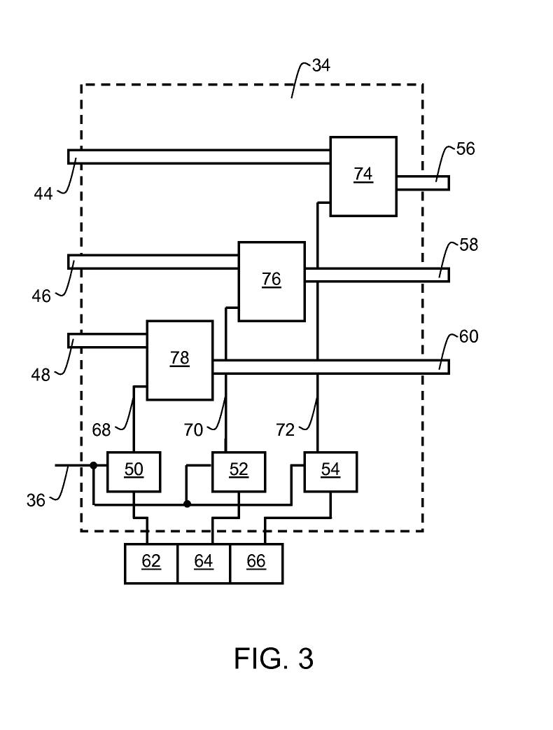

Referring to FIG. 3, an example of an embodiment of an image enhancement module 34 according to an embodiment of the display controlling unit 20 is schematically shown. The block diagram shows the functional blocks in temporal dithering operation and application of the safety mode signal 36. Temporal dithering allows emulating a color resolution higher than the color resolution supported by the display. The dithering is done by changing the intensity values of an image element over time sent to the display. The averaging done by the human eye may perceive the intensity of such alternating pixels as an interims value between the two supported intensity values. In the shown example, input image elements comprising three color components having a bit-depth of for example eight bits may be received by input channels 44, 46, 48 for R[7:0] (red) 44, G[7:0] (green) 46 and B[7:0] (blue) 48. Random Number Generator (RNG) devices 50, 52, 54 each may generate a random number or a pseudo-random number of, for example, up to three bits length, which may then be added to the components of the incoming image element or pixel. However, when the safety mode signal 36 is in the second mode, i.e. enabled or asserted, the number of bits generated by RNG devices 50, 52, 54 is zero thereby disabling the dithering of the image enhancement unit 34. The shown image enhancement module 34 may provide output data representing an output image element having three components 56, 58, 60 which is the same as the input data representing the input image element, when the safety mode signal 36 is in the second mode, i.e. either safety mode is active or the shown image enhancement module 34 may perform dithering on an incoming image element or pixel depending on the display that it interfaces with.

As shown in FIG. 3, the image enhancement module 34 may for example be connected to a configuration register 62, 64, 66 that allows selecting how many bits to add to each color component. The register may for example be six bits wide, two bits per color component. This may allow adding a 0.3 bit number to each of three color components. The setting may be done appropriately to reflect the color resolution of the display attached. Typical settings may for example be eight minus the number of color bits of the display. An initial value of the configuration register 62, 64, 66 may for example be 0x00 (hex), thereby effectively disabling the image enhancement module 34, i.e. the dithering block.

The image enhancement processing may comprise adding at least one random value to one or more image elements of the first set. The number of random values per image element may depend on the type of image. For example, a greyscale image may receive one, a three components color image, such as an RGB or YUV image may receive three random values per image element. In the example illustrated in FIG. 3, each RNG device 50, 52, 54 may provide a random number of up to 3 bits. The bits provided may be shifted to the least significant bits (LSB bits) of the 3-bit value outputs 68, 70, 72. The number of bits actually provided may be selected by the value provided by the configuration register 62, 64, 66. When the external safety mode signal is provided in the second mode, i.e. active, the number of bits generated by the RNG are zero. This may disable the temporal dithering for safety critical pixels when applied to input channels 44, 46, 48.

The RNG devices 50, 52, 54 may provide real random numbers or pseudo random numbers, which may have an average value of 0.5, distributed symmetrically around the 0.5 boundary.

Periodicity of the RNG may be significantly higher than the number of random bits required per image frame. Distribution of random numbers may for example be gaussian or white noise. As an example, implementation of RNG devices may comprise using linear feedback shift registers (LFSRs), wherein in an embodiment one LFSR may be sufficient for all three RNG devices 50, 52, 54.

The shown add & clamp blocks or circuits 74, 76, 78 may then each be arranged to add for example an eight-bit number received via input channel 44, 46, 48 and a three bit number received through 3-bit value outputs 68, 70, 72. After the addition the value may be clamped to the range 0.255. Numbers may be unsigned numbers. In an embodiment the image enhancement module 34 may comprise a gamma correction unit (not shown) adapted to perform gamma correction on the non-safety-relevant dithered image elements.

The addition of a random number to the input image elements received on channels 44, 46, 48 may cause the output image element provided on output channels 56, 58, 60 to be non-deterministic. Referring back to FIG. 2, the verification module 38 may be arranged to compare the second set 28 of image elements with a reference set. In order to achieve a reliable comparison result for guaranteeing integrity of the safety relevant image elements displayed, safety relevant image elements provided to the verification module 38 may not comprise a random component.

The verification module 38 may be arranged to calculate a checksum for the second set and to compare the checksum with a reference checksum, which may for example be calculated offline.

Since application of the safety mode signal 36, for example on a per pixel basis, allows protection from random value addition of image elements comprising safety relevant information, temporal dithering may be applied in applications where also safety relevant information is presented on the display, since a checksum may be calculated over the safety relevant pixels before comparing the checksum with a reference calculated offline, while performing image enhancement processing over the non-safety-relevant pixels only.

This may for example allow providing the user with enhanced image quality while using less expensive display screens which may provide a bit-depth less than the actually available input bit-depth, i.e. a number of quantization steps of the output image data may be less than a number of quantization steps of the input image data, while still being able to guarantee integrity of safety relevant information displayed on the same display device at the same time. For example, disabling of temporal dithering for safety critical information may allow a user to reduce system cost by using a cheaper RGB666 display while maintaining a high level of graphics quality and the integrity of the safety critical information.

An input image may for example be a single layer image. Or the input image data may comprise a plurality of image layers and the controlling unit 20 may comprise a blend or merging module 33 for composing an image from the plurality of layers. As illustrated in FIG. 2, the input image may for example comprise two layers, indicated by two times three differently dashed arrows, wherein three different arrows may correspond to a three components, e.g. RGB, color image. Merging of layers into a single image (indicated by three arrows) may be performed before image enhancement and verification, avoiding to subsequently cover verified safety relevant information with non-safety-relevant information which may have been subject to randomizing image enhancement. Or application of the safety mode may ensure that the content of a safety layer is visible on the display regardless of the settings in other layers and pixel manipulation algorithms.

The display controlling unit may for example be integrated on a single integrated circuit die, which may be produced at low cost in large quantities, or it may for example be integrated with existing display controller integrated circuits.

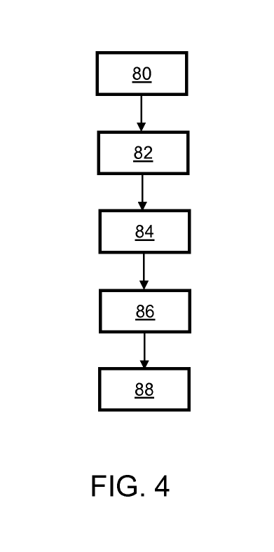

Referring now to FIG. 4, a diagram of a method for outputting image data is schematically shown. The illustrated method allows implementing the advantages and characteristics of the described display controlling unit as part of a method for outputting image data. A method for outputting image data may comprise receiving 80 input image data representing an input image comprising a first set and a second set of image elements; the second set of image elements comprising a safety relevant information; receiving 82 a safety mode signal; performing 84 an image enhancement processing for the first set when the safety mode signal indicates a first mode; performing 86 a verification processing for the second set when the safety mode signal indicates a second mode; and providing 88 output image data representing an output image at least comprising the second set of image elements.

Performing image enhancement processing 84 may for example comprise applying a noise signal to or dithering to the first set of image elements.

And a computer program product may comprise code portions for implementing parts of a display controlling unit or for executing code portions of a method as described above when run on a programmable apparatus. In an embodiment the term parts may refer to all parts. The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connections that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the image enhancement module 34 and verification module 38 may be implemented as a single module or separate modules.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. For example, the display controlling unit 20 may be implemented as a single integrated circuit. Alternatively, the example may be implemented as any number of separate integrated circuits or separate devices interconnected with each other in a suitable manner. For example, the modules of the display controlling unit 20 may be implemented as separate devices.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While the principles of the invention have been described above in connection with specific apparatus, it is to be clearly understood that this description is made only by way of example and not as a limitation on the scope of the invention.

1. A display controlling unit, comprising:
an input connectable to receive input image data representing an input image, wherein
the input image comprises a first set and a second set of image elements, and
said second set of image elements comprises a safety relevant information;
an output connectable to provide output image data representing an output image at least comprising said safety relevant information;
an image enhancement module arranged to perform image enhancement processing for said first set of image elements when a safety mode signal indicates a first mode; and
a verification module arranged to perform a verification processing for said second set of image elements when said safety mode signal indicates a second mode.

2. The display controlling unit as claimed in claim 1, comprising a safety mode controlling module connected to said image enhancement module and said verification module, wherein the safety mode is arranged to provide said safety mode signal.

3. The display controlling unit as claimed in claim 1, adapted to provide said second set of image elements to one or more specific sections of a display coupled to said output, wherein said one or more specific sections are dedicated to displaying said safety relevant information.

4. The display controlling unit as claimed in claim 1, wherein said image enhancement module is arranged to apply a noise signal to said first set of image elements.

5. The display controlling unit as claimed in claim 1, wherein said image enhancement module is arranged to dither said first set of image elements.

6. The display control unit as claimed in claim 5, wherein said dithering comprises a temporal dithering of said first set of image elements.

7. The display controlling unit as claimed in claim 1, wherein the output is arranged to provide output a sequence of output images.

8. The display controlling unit as claimed in claim 1, wherein said image enhancement processing comprises adding at least one random value to one or more image elements of said first set of image elements.

9. The display controlling unit as claimed in claim 1, wherein said verification module is arranged to compare said second set of image elements with a reference set.

10. The display controlling unit as claimed in claim 9, wherein said verification module is arranged to calculate a checksum for said second set and to compare said checksum with a reference checksum.

11. The display controlling unit as claimed in claim 1, wherein a number of quantization steps of said output image data is less than a number of quantization steps of said input image data.

12. The display controlling unit as claimed in claim 1, wherein said input image data comprises a plurality of image layers and wherein said display controlling unit further comprises a merging module for composing an image from said plurality of layers.

13. The display controlling unit as claimed in claim 1, wherein said display controlling unit is integrated on a single integrated circuit die.

14. An image displaying system, comprising a display controlling unit as claimed in claim 1 and further comprising:
a display connected to receive said output image data and arranged to output an image in a for humans perceptible form; and
at least one image data source connected to provide said input image data.

15. A method for outputting image data, the method comprising:
receiving input image data representing an input image comprising a first set and a second set of image elements, wherein said second set of image elements comprises a safety relevant information;
receiving a safety mode signal;
performing an image enhancement processing for said first set when said safety mode signal indicates a first mode;
performing a verification processing for said second set when said safety mode signal indicates a second mode; and
providing output image data representing an output image at least comprising said second set of image elements.

16. The method of claim 15 further comprising:
displaying said second set of image elements on one or more specific sections of a display unit, wherein the one or more specific sections are dedicated to displaying safety relevant information.

17. The method of claim 15 wherein said image enhancement processing comprises:
applying a noise signal to said first set of image elements.

18. The method of claim 15 wherein said image enhancement processing comprises:
dithering said first set of image elements.

19. The method of claim 18 wherein said dithering said first set of image elements comprises temporal dithering.

20. The method of claim 15 wherein said verification processing comprises comparing said second set of image elements with a reference set.
